(19) United States
(12) Patent Application Publication
(10) Pub. No.: US 2025/0146320 A1
(43) Pub. Date: May 8, 2025

(54) GLARE MITIGATION CANOPY

(71) Applicant: HUDSON SPIDER LLC, Valencia, CA (US)

(72) Inventor: Timothy John Hudson, Santa Clarita, CA (US)

(73) Assignee: HUDSON SPIDER LLC, Valencia, CA (US)

(21) Appl. No.: 18/386,567

(22) Filed: Nov. 2, 2023

(51) Int. Cl. E04H 15/00

(52) U.S. Cl. CPC E04H 15/008

(57) ABSTRACT

A glare mitigation accessory that may be easily carried by a person, and which may be easily mounted on readily accessible equipment. The glare mitigation accessory may be a three-sided shade having a roof or top panel with two layers open at one edge and closed at least at portions of the other edges to form a pocket. The readily accessible equipment may be a floppy mounted on a stand. The combined floppy and glare mitigation accessory may be used in a configuration having 0-4 open sides depending on lighting conditions or need for privacy.

### BACKGROUND OF THE INVENTION

### 1. Field of the Invention

The invention relates to sunshades and more particularly, an accessory structure to reduce glare on an electronic display.

### 2. Description of the Related Technology

Location shooting is the shooting of a film or television production in a real-world setting rather than a sound stage or backlot. The location may be interior or exterior. The filming location may be the same in which the story is set. Most films feature a combination of location and studio shoots; often, interior scenes will be shot on a soundstage while exterior scenes will be shot on location.

Location shooting has several advantages over filming on a studio set. First and foremost, the expense can often be far lower than that of constructing sets in a studio. The illusion of reality can also be stronger; on a set, it is hard to replicate real-world wear and tear, as well as architectural details, and the vastness of a city is difficult to recreate on a backlot. The failure of Camelot (1967) caused American filmmakers to shift exterior shots from studio backlots to authentic locations. The film was widely criticized for its cheap look because it was obviously filmed on an architecturally ambiguous set against the chaparral-covered hills of Burbank.

Conversely, there are a number of reasons why a production may choose not to shoot on location. Shooting on a set gives the crew greater control over the environment: a room may be created to the exacting specifications of the story, for example, and there is no need to shut down street traffic when shooting on a backlot. Additionally, a given location may have inconvenient restrictions. The convenience store where Clerks was shot was open during the day, so the crew could only shoot at night; this necessitated the shutters on the windows be closed to hide the fact that it was dark outside.

Location shooting often takes place outside. This presents lighting challenges including glare. In addition, many location shoots are far from the home studio, which can reduce access to equipment and hardware.

One of the challenges of any exterior shooting is managing lighting conditions. The primary element of lighting management is proper lighting of the scene, however, another element is the management of glare that interferes with viewing images on displays.

Glare is the difficulty of seeing in the presence of bright light such as direct or reflected sunlight or artificial light such as car headlamps at night. Because of this, some cars include mirrors with automatic anti-glare functions, and in buildings, blinds or louvers are often used to protect occupants. Glare is caused by a significant ratio of luminance between the task (that which is being looked at) and the glare source. Factors such as the angle between the task and the glare source and eye adaptation have significant impacts on the experience of glare. Because glare management for the use of displays is not the focus of lighting management, glare management measures are not attended to by the crew making it difficult for those using displays.

Glare can be generally divided into two types, discomfort glare and disability glare. Discomfort glare is a psychological sensation caused by high brightness (or brightness contrast) within the field of view, which does not necessarily impair vision. In buildings, discomfort glare can originate from small artificial lights (e.g. ceiling fixtures) that have brightnesses that are significantly greater than their surrounding. When the luminous source occupies a much greater portion of the visual field (e.g. daylit windows), discomfort caused by glare can be linked to a saturating effect. Since observers will not always look directly at a bright illuminated source, discomfort glare usually arises when an observer is focusing on a visual task (e.g. a computer-screen) and the bright source is within their peripheral visual field.

Disability glare impairs the vision of objects without necessarily causing discomfort. This could arise for instance when driving westward at sunset. Disability glare is often caused by the inter-reflection of light within the eyeball, reducing the contrast between task and glare source to the point where the task cannot be distinguished. When glare is so intense that vision is completely impaired, it is sometimes called dazzle.

Glare can be problematic, if while driving the ability to determine the distance and speed of passing cars is reduced. Glare can be reduced visibility for by reducing brightness of the rest of the scene by constriction of the pupils. Reduction in contrast of the rest of the scene by scattering of the bright light within the eye also reduces the effects of glare. A reduction in contrast between print and paper may be achieved by reflection of the light source in the printed matter may reduce glare. Reduction in contrast by reflection of bright areas on the surface of a transparent medium as glass, plastic or water; for example when the sky is reflected in a lake, so that the bottom below or objects in the water cannot be seen may reduce glare.

Bloom surrounding objects in front of glare reduces the affects of the glare.

Sunglasses are often worn to reduce glare; polarized sunglasses are designed to reduce glare caused by reflected light, for example light reflected from surfaces such as water, glossy printed matter, or painted surfaces. An anti- reflective treatment on eyeglasses reduces the glare at night and glare from inside lights and computer screens that is caused by light bouncing off the lens. Some types of eyeglasses can reduce glare that occurs because of the imperfections on the surface of the eye.

The International Commission on Illumination (CIE) defines glare as “Visual conditions in which there is excessive contrast or an inappropriate distribution of light sources that disturbs the observer or limits the ability to distinguish details and objects”.

A glossy display is an electronic display with a glossy surface. In certain light environments, glossy displays provide better color intensity and contrast ratios than matte displays. The primary disadvantage of glossy displays is their tendency to reflect any external light, often resulting in an undesirable glare.

Some LCDs use an anti-reflective coating or a nanotextured glass surface to reduce the amount of external light reflecting from the surface without affecting light emanating from the screen as an alternative to matte display. Because of the reflective nature of the display, in most lighting conditions that include direct light sources facing the screen, glossy displays create reflections, which can be distracting to the user of the computer. This can be especially distracting to users working in an environment where the position of lights and windows are fixed, such as in an office, as these create unavoidable reflections on glossy displays.

In controlled environments such as darkened rooms, or rooms where all light sources are diffused, glossy displays create more saturated colors, deeper blacks, and brighter whites, and are sharper than matte displays. This is why supporters of glossy screens consider these types of displays more appropriate for viewing photographs and watching films.

When using a display outdoors, such as driving an exterior location shoot or at an outdoor sporting event, glare management is accomplished by structures placed to shield a display from glare-inducing light sources. Camera Operators use various hood structures. Booths or tents may be set up to provide a darkened environment for viewing displays. For example, instant replay officials may have booth-shaped tents to provide shade.

In the filmmaking process, a crew is needed to make everything happen. The term “film crew” can refer to many things but typically it is composed of people involved with producing films. A film crew is a group of people that work together on the set of a movie or other production. The crew can range from as few as three to over one hundred people. They have many different jobs, and each person has his or her own responsibilities for what they are doing at any given time. Some examples include Director; Director of Photography (aka Cinematographer); Camera Operator; and Gaffer (lighting).

The crew is responsible for many aspects of the production, including getting equipment from one place to another and making sure it is set up in time for filming. The crew may also include technicians such as camera operators, stage managers, sound engineers, makeup artists, and costume designers.

A film crew's jobs may include setting up equipment; providing transportation services; equipment maintenance and repair; and performing tasks related to preproduction activities such as blocking scenes and running lines.

When someone on set experiences glare, particularly when using a laptop or viewing images or video on a display, they often must rely on the crew to set up appropriate measures to mitigate the glare. A problem arises when the crew has access only to limited resources and when the priorities on set do not include glare mitigation (other than for the director and camera operators).

A film crew may use a “floppy” to manage glare. A “floppy” is a piece of equipment which is often found on a film set. According to the Ocean Studio online film media glossary, a floppy is a flag that has a built-in tear-away flap that can increase its effective surface area. The most common size of flag used by film crews that is referred to as floppy is a 4×4 floppy. These flags measure 4 feet by 4 foot and have a second piece of material, the flap, connected to one edge of the flag. Velcro tabs may keep the floppy flap attached to the flag for storage or minimized use. When a larger surface area is required, the flap can be put into use by pulling on the Velcro to release the flap of material. In this way, the floppy can be mounted on a stand in a horizontal orientation and the flap may hang down from one edge of the flag in a vertical orientation.

FIG. 1 and FIG. 1A show a prior art floppy of the type that is often available on location. The floppy has a flag 3 that may be mounted on a frame 5 attached to a stand 1. The floppy may have a flap 2 that is draped from the flag 3. Flag 3 may be a cloth or other material mounted on a frame 5 or be a rigid or flexible (floppy) board. When mounted on stand 1 flag 3 may be oriented horizontally or another desirable orientation. Flap 2 may be horizontally oriented. The floppy may include an arrangement suitable for mounting the floppy on stand 1. Depending on the particular setup, the floppy may be horizontal or at some other desired angle. The floppy may be a somewhat flexible sheet with sufficient rigidity or support to be held in place. FIG. 1A shows an example of a floppy support frame 5. A mounting arm 6 may be attached to frame 5 and struts 7 may be in place to add structural integrity to the floppy frame 5.

### SUMMARY OF THE INVENTION

It is an object to provide an apparatus for glare mitigation such as a mobile screening area suitable for use on location. It is a further object to provide a shading device that is mobile and easily set up to facilitate privacy and/or use of electronic displays in locations with glare conditions or a need for privacy.

It is a further object to provide a screening structure that may be folded by anyone who needs it and placed in a personal tote or backpack. It is a further object to provide a canopy that may be used as an accessory to a floppy that enhances protection from glare, does not require any crew to add to a floppy, and does not require the production company to maintain additional inventory.

Film locations typically have a myriad of equipment and individuals with specific responsibilities for such equipment. The primary objective on location is to capture the subject matter being filmed. There are many people on set and more in the digital age of film production that require the use of a screen. The screens may be laptop computers, video monitors, camera viewfinders, etc. When filming on location, lighting conditions, such as daylight, can create sun glare and often those individuals who are required to utilize equipment with an electronic display screen need some structure to be able to avoid or mitigate glare. One structure that can be provided on set is a floppy set-up on a stand. Other structures that may be found on location for this purpose may include flexible hoods such as those used by replay officials during NFL games. There also exist 3- and 4-sided tent structures which may be used for the purpose. No one structure is ideal for all circumstances. While tent structures are useful, they typically take time to set up and can require a crew member to erect, manage, and take down. Often crew members are busy with other activities, and it may be difficult for someone needing to use an electronic display and avoid glare on an ad hoc basis. Tent structures are often not available and/or crew to set up tent structures are often not available. The device described herein may be utilized by an individual requiring a screening area or shade, particularly on an ad hoc basis without requiring crew members to set up the equipment and without requiring maintenance of an inventory of tents on location. The canopy described is intended as an “accessory” to a floppy which is common on location.

The canopy may include a top panel having two layers of flexible material connected to each other on parts of the perimeter of the panel and having at least one opening along at least a portion of an edge of the panel. The layers are not connected to each other in at least an area accessible through said opening and configured to permit the insertion of support through the opening and into the area between the layers. Elsewhere, the layers may be bonded to each other. A drape or flap may be connected to the top panel. The top panel may be rectangular.

The two layers of flexible material may be connected on three sides of the top panel and open on the fourth side of the top panel. The drapes may be connected to the top panel on said three sides of said top panel. The canopy drapes may include a first drape connected to the first side of the top panel, a second drape connected to the second side of said top panel, and a third drape connected to the third side of the top panel.

Various objects, features, aspects, and advantages of the present invention will become more apparent from the following detailed description of preferred embodiments of the invention, along with the accompanying drawings in which the same numerals represent like components.

Moreover, the above objects and advantages of the invention are illustrative, and not exhaustive, of those that can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

FIG. 1 shows a prior art floppy mounted on a stand.

FIG. 1A shows a prior art floppy frame.

FIG. 2 shows a glare mitigation canopy.

FIG. 3 shows the glare mitigation canopy of FIG. 2 mounted on the floppy shown in FIG. 1.

FIG. 4 shows a laid-out version of the canopy.

FIG. 5 illustrates the structural elements of the canopy.

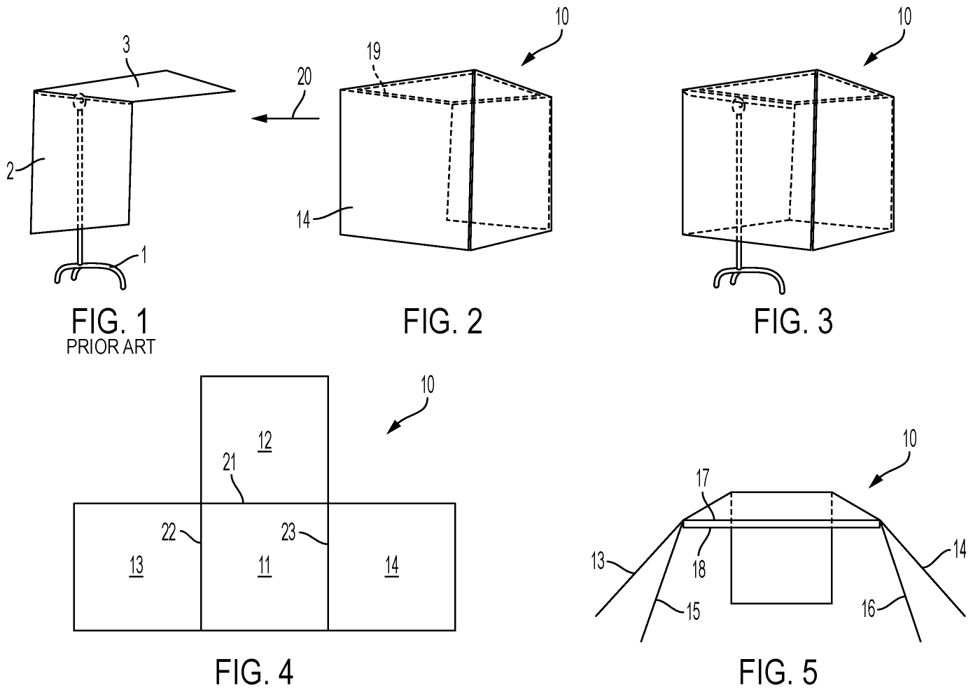

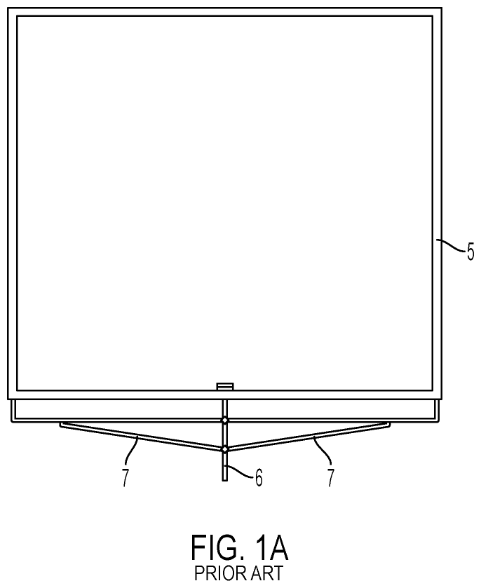

### DETAILED DESCRIPTION OF THE PREFERRED EMBODIMENT

Before the present invention is described in further detail, it is to be understood that the invention is not limited to the particular embodiments described, which as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

FIG. 2 shows a canopy that may be used as a glare mitigation accessory to a floppy and FIG. 3 shows the canopy installed on a floppy which in turn is mounted on a stand.

FIG. 4 shows the geometry of the canopy in a laid-put orientation and FIG. 5 schematically shows the structural elements of the canopy. FIGS. 2-5 are described with the use of reference numbers consistent across the figures.

Canopy 10 may advantageously have 4-panel sections. A top panel section 11 may be provided. Advantageously, top panel section 11 is configured for mounting on a floppy or a floppy frame. Front panel section 12 may be attached to the top panel section 11 at the front edge 21 of the top panel section 11. A side panel section 13 may be attached to the top panel section 11 at edge 22 of the top panel section 11 on the side adjacent to where the front panel section 12 is attached to the top panel section 11. A side panel section 14 may be attached to the top panel section 11 at edge 23 of the top panel section 11 on the side opposing the side panel section 13. The top panel section 11, front panel section 12, and side panel sections 13 and 14 may be attached by various mechanisms. They may be sewn together, they may be buckled, they may be attached by straps which are tied, snaps may be utilized, as well as hook and loop fasteners (Velcro®). It is possible to have one or more of the panel sections 12, 13, and 14 be part of the same sheet of material that forms the top panel section 11. Other mechanisms may also be utilized to attach the panels to each other.

Advantageously, the top panel section 11 may have 2 layers connected to each other on three sides. The 2 layers may be open on one side thus defining a “pocket”. Advantageously, the open side is the side that does not have side panel sections 13 or 14, or front panel section 12 attached. The top panel section 11 may be structured as a pocket and may slide over the floppy or floppy frame 5. The attachment may be by any suitable method, for example, straps may be utilized to hold the top panel section in place on the floppy. The straps may be tied. The straps may be Velcro. The straps may include magnets arranged to cooperate with opposing magnets or metal mounted on, or part of the floppy on a stand structure. Each panel of canopy 10 may be made from a sheet material having sufficient opacity to reduce glare to an acceptable level within the glare mitigation canopy mounted on a floppy stand. Each panel section may be constructed, for example, from vinyl sheets. Advantageously, an exterior vinyl sheet and an interior vinyl sheet. The exterior vinyl sheets may advantageously be white or light in color to reflect light and heat, or at least reduce absorption. The interior sheet may be black or dark in color in order to enhance its opacity. One or more of the side panel sections 13, 14 and the front panel section 12 may be provided with additional panels. The additional panels may have a low opacity which operates to somewhat reduce glare, but still allow some level of transparency. For example, inner panel sections 15 and 16 may be mesh screen. Advantageously, the outer panels may include ties or other fasteners to facilitate the outer panels being held up, for example, by being rolled and tied or buckled. The inner sheets 15 may be permanently or removably connected to the panel structure or the top panel 11. The canopy may have outer panels that are water-resistant or water-repellent. The canopy may have auxiliary water-resistant or water-repellent layers that may be rolled up to add breathability when not needed for protection from moisture. Fasteners may be provided to tie off or hold the auxiliary water-resistant or water- repellent layers. The fasteners may be straps or other structures that may easily be put into service to hold the auxiliary water-resistant or water-repellent layers when not needed. According to an embodiment, a panel may have an inner breathable layer having a dark color, an intermediate breathable layer having a light color, and an outer auxiliary water-resistant or water-repellent layer having a light color.

The invention is described in detail with respect to preferred embodiments, and it will now be apparent from the foregoing to those skilled in the art that changes and modifications may be made without departing from the invention in its broader aspects, and the invention, therefore, as defined in the claims, is intended to cover all such changes and modifications that fall within the true spirit of the invention.

Thus, specific apparatus for and methods of glare mitigation have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non- exclusive manner, indicating that the referenced elements, components, or steps may be present, or utilized, or combined with other elements, components, or steps that are not expressly referenced.

What is claimed is:

1. Canopy comprising:
a top panel having two layers of flexible material connected to each other on parts of a perimeter of said layer and having at least one opening along at least a portion of a mounting edge of said panel, wherein said layers are not connected in at least an area accessible through said opening and configured to permit insertion of a support through said opening and into said area; and
a drape connected to a first edge of said top panel.

2. The canopy according to claim 1 wherein said top panel is rectangular.

3. The canopy according to claim 2 wherein said two layers of flexible material are connected on three edges of said top panel and open on a fourth edge of said top panel.

4. The canopy according to claim 3 further comprising a second drape connected to a second edge of said top panel and a third drape connected to a third edge of said top panel.

5. The canopy according to claim 4 wherein said top panel further comprises a water resistant layer.

6. The canopy according to claim 5 wherein said drapes comprise dark colored vinyl bonded to a light colored vinyl wherein said dark colored vinyl faces out.

7. The canopy according to claim 6 wherein at least one of said drapes includes a mesh layer.

8. The canopy according to claim 7 further comprising straps connected to said top panel.
